(19) United States
(12) Patent Application Publication
(10) Pub. No.: US 2022/0053130 A1
(43) Pub. Date: Feb. 17, 2022

(54) MULTIFUNCTIONAL CAMERA

(71) Applicant: Magic Control Technology Corporation, New Taipei City (TW)

(72) Inventor: PEI-CHUNG LIU, New Taipei City (TW)

(21) Appl. No.: 17/333,034

(22) Filed: May 28, 2021

Related U.S. Application Data
(60) Provisional application No. 63/064,886, filed on Aug. 12, 2020.

(30) Foreign Application Priority Data
Dec. 24, 2020 (TW) 109146069

(51) Int. Cl. H04N 5/232

(52) U.S. Cl. CPC H04N 5/23245; H04N 5/23238; H04N 5/23296

(57) ABSTRACT

Provided is a multifunctional camera, including a support part and a camera unit. The camera unit is disposed on the support part and is capable of being adjusted to at least one shooting angle. The camera unit includes a processor that can adjust the camera unit to be corresponding to the at least one shooting angle according to a switching signal.

### CROSS-REFERENCE TO RELATED APPLICATION

This application claims the priorities of U.S. provisional application No. 63/064,886, filed on Aug. 12, 2020, and Taiwanese patent application No. 109146069, filed on Dec. 24, 2020, which are incorporated herewith by reference.

### BACKGROUND OF THE INVENTION

### 1. Field of the Invention

The present invention relates to a multifunctional camera, and more particularly to a multifunctional camera, which can be switched to different shooting angles for shooting.

### 2. The Prior Arts

With the development of 360-degree panorama camera and display technologies, many cameras that can support different modes have appeared in the field, such as a camera 3 shown in FIG. 1A, which is a multifunctional camera that can support different modes shown in FIGS. 1B-1E. FIG. 1B is a schematic diagram of a single mode of the multifunctional camera in FIG. 1A. FIG. 1C is a schematic diagram of a fixed range mode of the multifunctional camera in FIG. 1A, which shows multiple shooting targets within the field of view. FIG. 1D is a schematic diagram of a full screen mode of the multifunctional camera in FIG. 1A, which is a split screen showing multiple shooting targets at the same time. FIG. 1E is a schematic diagram of a 360-degree panorama mode of the multifunctional camera in FIG. 1A, which directly shows the scene shot by a 360 degree lens. It should be noted that the conventional lenses of the camera 3 face upwards. As shown in FIG. 1F, the fisheye lens of the camera 3 faces toward four shooting targets at 0 degree, 90 degrees, 180 degrees, and 270 degrees for shooting. Therefore, the images of FIG. 1B and FIG. 1C are all captured from the image of FIG. 1E and then processed by zooming in.

However, the camera also needs to be upgraded with the increase in the resolution of various display devices, and requires different modes to meet various requirements. Therefore, it is necessary to provide an improved camera structure and a shooting method to allow the multifunctional camera to have a wider shooting range and more shooting angle modes.

### SUMMARY OF THE INVENTION

The present invention provides a multifunctional camera, comprising a support part and a camera unit. The camera unit is disposed on the support part, is capable of being adjusted to at least one shooting angle. The camera unit includes a processor that can adjust the camera unit to be corresponding to the at least one shooting angle according to a switching signal. The at least one shooting angle corresponds to at least one shooting mode.

In an embodiment, the camera unit includes a gyro sensor coupled to the processor and detecting the at least one shooting angle to generate and input the switching signal to the processor.

In an embodiment, the multifunctional camera further comprises an input unit receiving a user input signal to generate and input the switching signal to the processor.

In an embodiment, the camera unit may be adjusted to a first shooting angle or a second shooting angle.

In an embodiment, the at least one shooting mode corresponding to the first shooting angle includes a full screen mode, a panoramic mode, a host mode, and a two speaker mode.

In an embodiment, the at least one shooting mode corresponding to the second shooting angle includes a single view S mode and a single view L mode.

The multifunctional camera of the present invention can be adjusted to at least one shooting angle, which corresponds to at least one shooting mode, to provide a larger shooting range and more shooting angle modes.

### BRIEF DESCRIPTION OF THE DRAWINGS

FIG. 1A is a schematic diagram of a conventional multifunctional camera;

FIGS. 1B-1E are schematic diagrams of multiple shooting modes of the multifunctional camera in FIG. 1A;

FIG. 1F is a schematic diagram of the shooting angle of the conventional multifunctional camera;

FIG. 1G is a schematic diagram of a first shooting angle of a multifunctional camera according to an embodiment of the present invention;

FIG. 1H is a schematic diagram of a second shooting angle of the multifunctional camera according to an embodiment of the present invention;

FIGS. 2A-2F are schematic diagrams of multiple shooting modes of the multifunctional camera according to an embodiment of the present invention;

FIGS. 3A-3E are schematic comparison diagrams between the conventional multifunctional camera in FIG. 1A and the multifunctional camera according to the embodiment of the present invention in the multiple shooting modes;

FIG. 4A is a block diagram of a camera unit according to an embodiment of the present invention;

FIG. 4B is a block diagram of a camera unit according to another embodiment of the present invention;

FIG. 5A is a flowchart of image processing according to an embodiment of the present invention;

FIG. 5B is a flowchart of image processing according to another embodiment of the present invention;

FIG. 5C is a schematic diagram corresponding to FIG. 5A; and

FIG. 5D is a schematic diagram corresponding to FIG. 5B.

### DETAILED DESCRIPTION OF THE PREFERRED EMBODIMENT

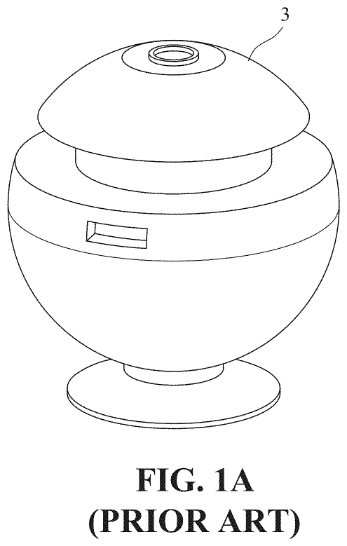

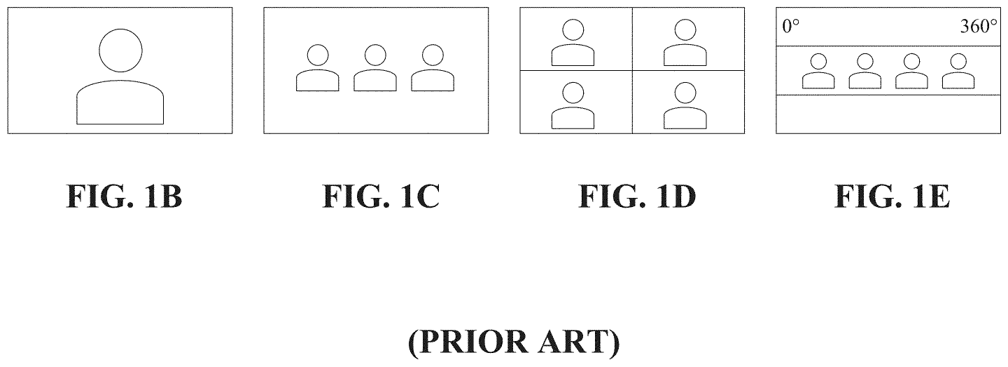

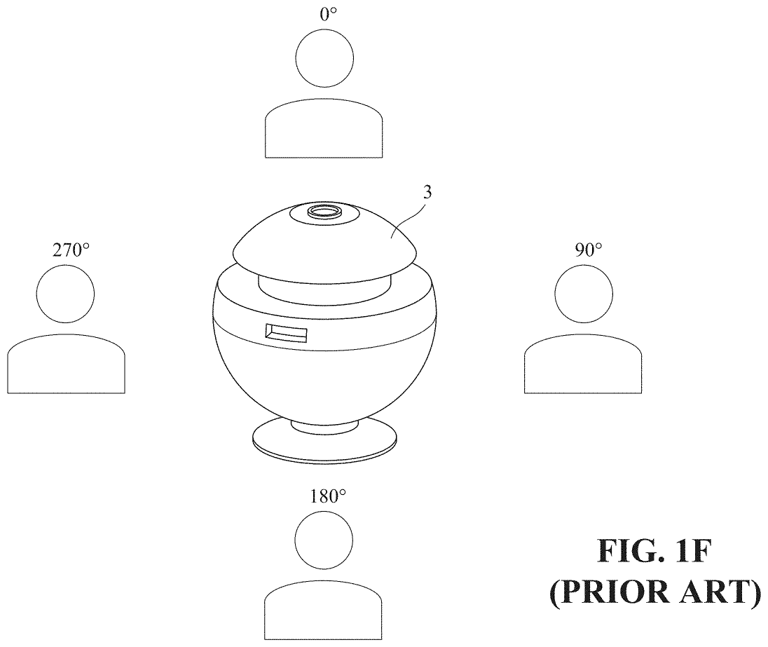

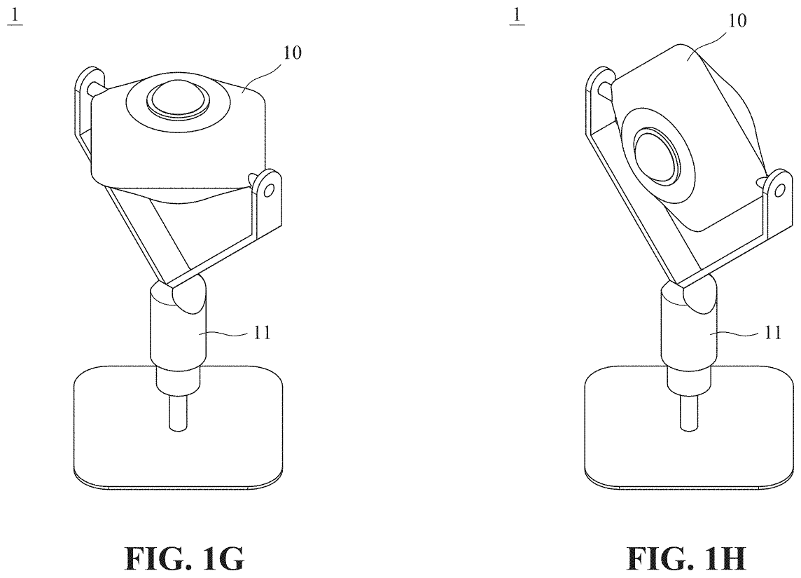

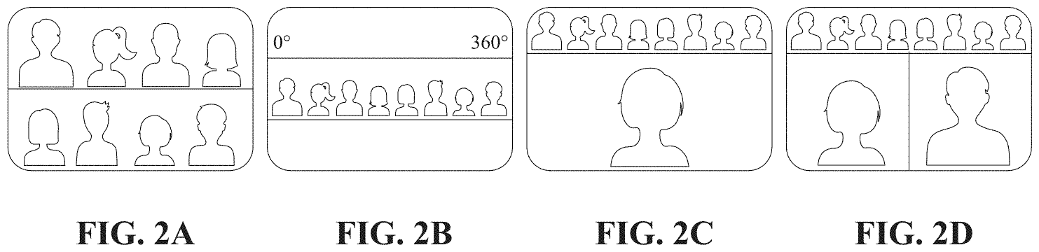

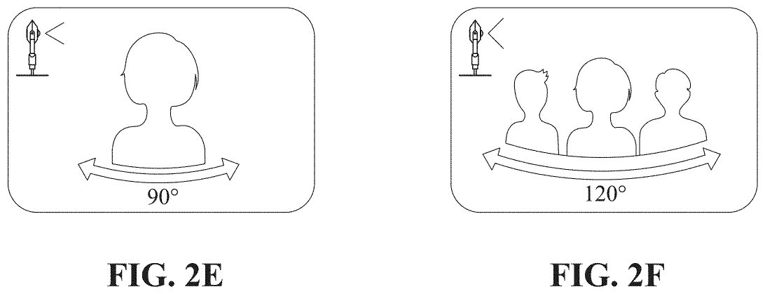

With reference to FIG. 1G and FIG. 1H, the present invention provides a multifunctional camera 1 comprising a support part 11 and a camera unit 10. The camera unit 10 is disposed on the support part 11 and can be adjusted to at least one shooting angle, which includes a first shooting angle of FIG. 1G and a second shooting angle of FIG. 1H in this embodiment. The camera unit 10 includes a processor that can adjust the camera unit 10 to be corresponding to the at least one shooting angle according to a switching signal. The at least one shooting angle corresponds to at least one shooting mode. In this embodiment, four shooting modes with respect to the first shooting angle are shown in FIGS. 2A to 2D, and two shooting modes with respect to the second shooting angle are shown in FIGS. 2E to 2F, in which FIG. 2A is a full screen mode, FIG. 2B is a panoramic (360 degree) mode, FIG. 2C is a host mode, FIG. 2D is a two speaker mode, FIG. 2E is a single view S mode, and FIG. 2F is a single view L mode. That is, as shown in FIG. 2A, when the first shooting angle of FIG. 1G is used, the display screen in the full-screen mode is a split screen showing multiple shooting targets at the same time. As shown in FIG. 2B, when the first shooting angle of FIG. 1G is used, the display screen in the full screen mode directly presents the scene shot by a 360-degree lens. As shown in FIG. 2C and FIG. 2D, when the first shooting angle of FIG. 1G is used, the host mode of FIG. 2C and the two speaker mode of FIG. 2D are respectively based on one and two shooting target images as the main image. The zoomed out display of the panorama mode is simultaneously displayed on a side thereof. As shown in FIG. 2E, when the second shooting angle of FIG. 1H is used, the display screen in the single view (S) mode will display a shooting target, which directly faces toward the camera, for example, a front side of the shooting target. As shown in FIG. 2F, when the second shooting angle of FIG. 1H is used, the display screen in the single view (L) mode will display two shooting targets, which directly face toward the camera, for example, a front side of the two shooting targets.

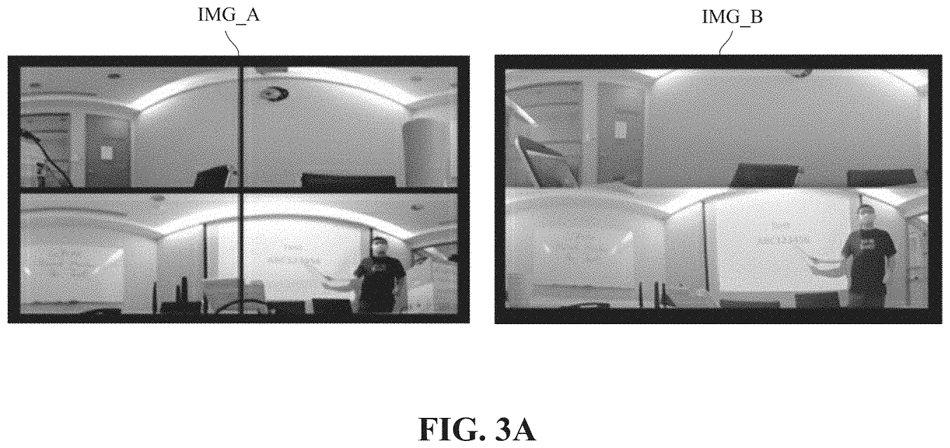

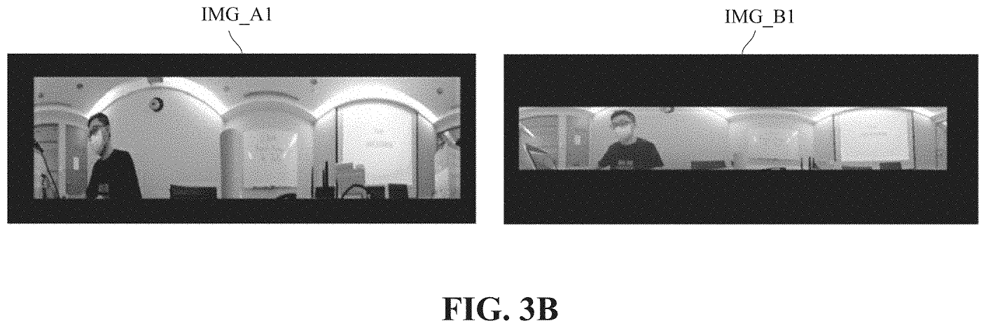

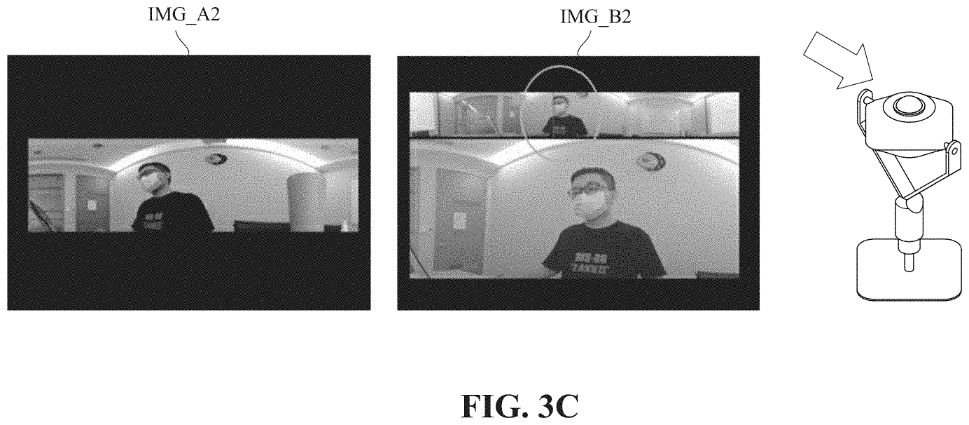

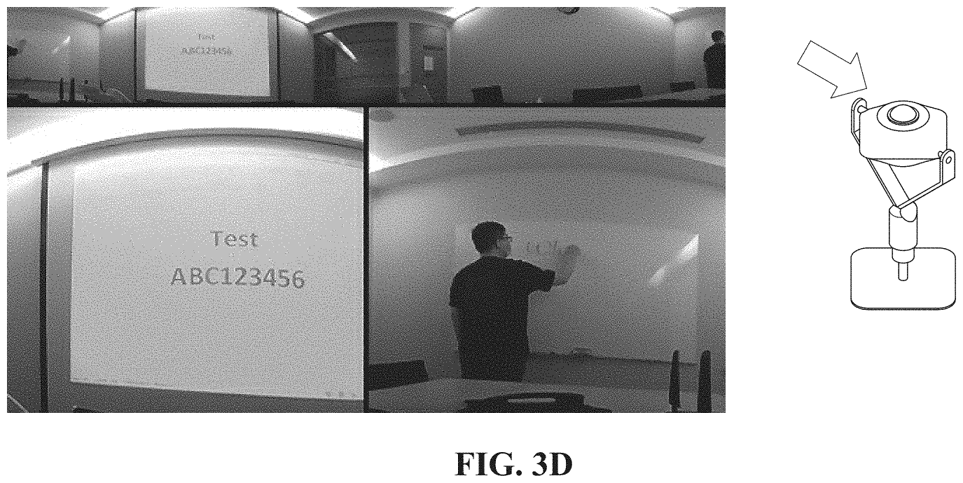

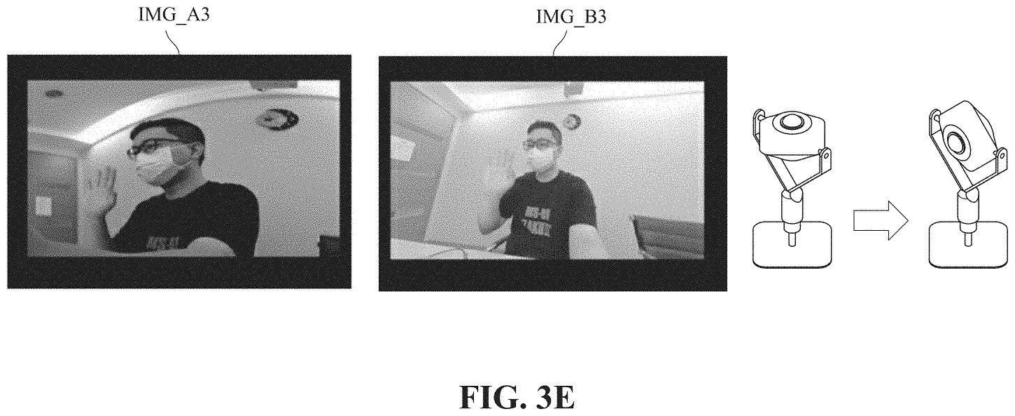

FIG. 3A is an image comparison of the full screen mode at the first shooting angle between the multifunctional camera 1 of the present invention and the conventional camera 3. The image IMG_A of the camera 3 is relatively distorted. The image IMG_B of the multifunctional camera 1 of the present invention on the projection screen and the white board is clearer and sharper.

FIG. 3B is an image comparison of the panorama (360 degree) mode at the first shooting angle between the multifunctional camera 1 of the present invention and the conventional camera 3. The image IMG_A1 of the camera 3 is distorted relative to the image IMG_B1 of the multifunctional camera 1 of the present invention.

FIG. 3C is an image comparison of the host mode at the first shooting angle between the multifunctional camera 1 of the present invention and the conventional camera 3. The image IMG_B2 of the multifunctional camera 1 of the present invention shows a touch bar in a circle, which allows the user to specify a display area, while the image IMG_A2 of the conventional camera 3 only provides a single field of view and cannot specify a display area.

FIG. 3D is a two speaker mode of the multifunctional camera 1 of the present invention at the first shooting angle. The present invention provides the touch bar as shown in FIG. 3C to allow the user to specify two display areas, while the conventional camera 3 does not have this function.

FIG. 3E is an image comparison of the single view (S) mode at the second shooting angle between the multifunctional camera 1 of the present invention and the conventional camera 3. The range of the image IMG_A3 of the conventional camera 3 is smaller than that of the image IMG_B3 of the multifunctional camera 1 of the present invention.

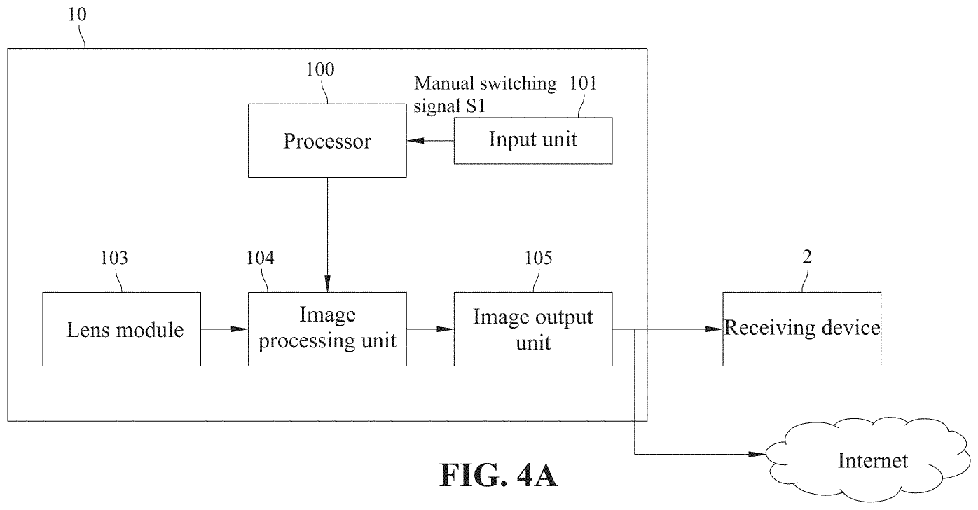

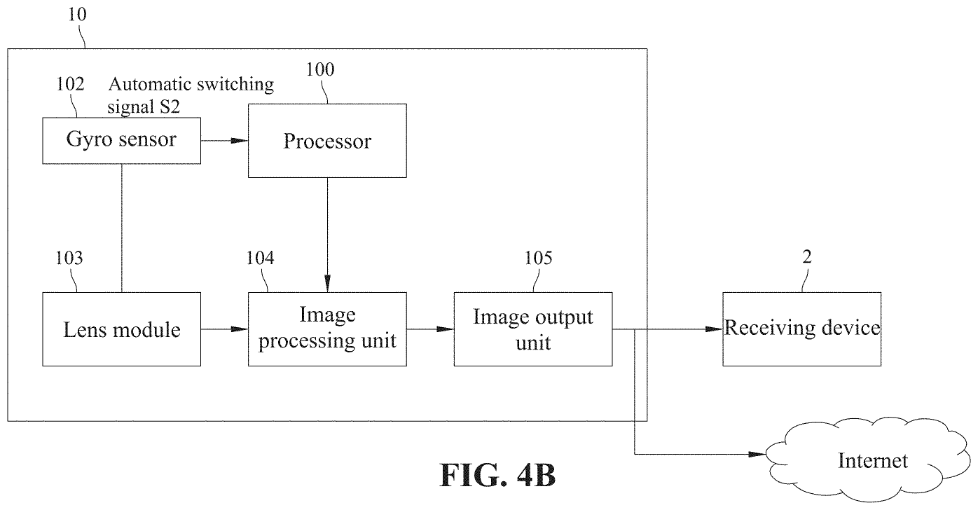

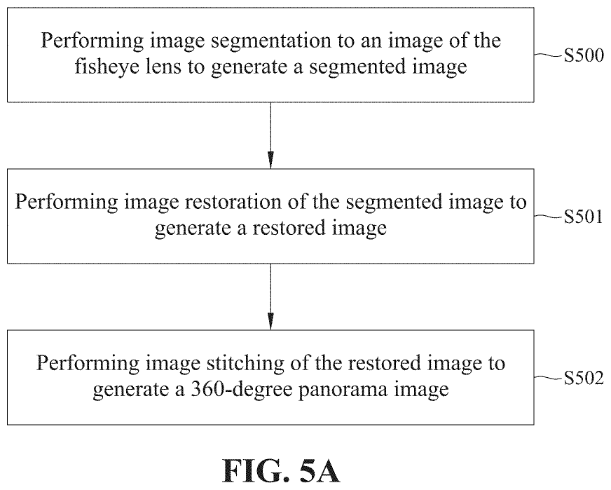

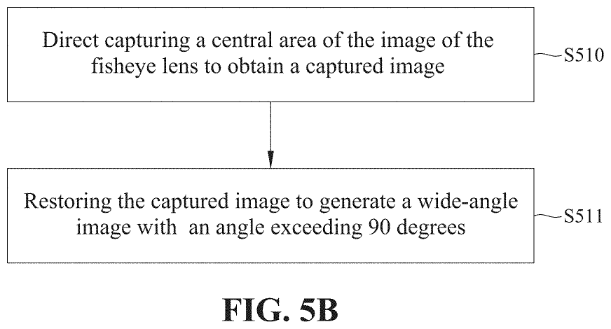

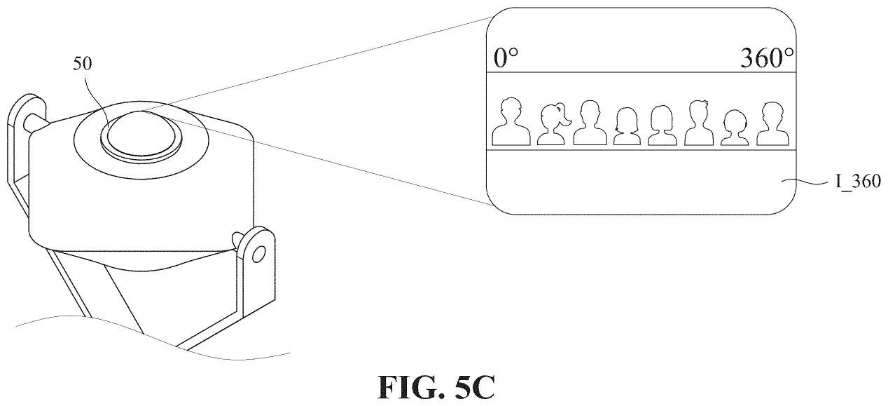

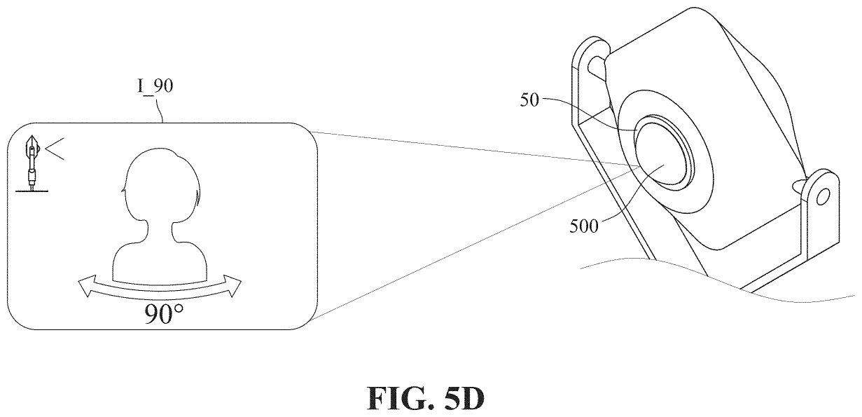

Please refer to FIGS. 4A and 4B, which respectively are block diagrams of a camera unit 10 and a camera unit 10′ according to an embodiment of the present invention. The camera unit 10 of FIG. 4A includes an input unit 101. The input unit 101, such as a switch button or a rotary axis switch, receives a user input signal to generate a manual switching signal S1 as the switching signal input to the processor 100. The camera unit 10′ of FIG. 4B includes a gyro sensor 102, which is coupled to the processor 100 and can detect the at least one shooting angle to generate an automatic switching signal S2 as the switching signal input to the processor 100. The camera unit 10 and the camera unit 10′ further include a lens module 103, an image processing unit 104 connected to the lens module 103 and the processor 100, and an image output unit 105 connected to the image processing unit 104. The gyro sensor 102 of the camera unit 10′ is coupled to the lens module 103 to detect a change of an angle of the lens module 103. The image processing performed by the image processing unit 104 includes an image signal processing (ISP), an image dewarping, an image cutting, an image stitching, etc. The processor 100 makes the image processing unit 104 perform the different image processing mentioned above according to the switching signal. With reference to FIGS. 5A to 5D, in this embodiment, the lens module 103 includes a fisheye lens 50. FIG. 5A is a flowchart of image processing according to an embodiment of the present invention, which converts the image of the fisheye lens 50 into a planar (2D) surrounding scene image, and includes step S500: performing image segmentation to an image of the fisheye lens 50 to generate a segmented image; step S501: performing image restoration of the segmented image to generate a restored image; step S502: performing image stitching of the restored image to generate a 360-degree panorama image I_360. FIG. 5C is a schematic diagram corresponding to FIG. 5A. FIG. 5B is a flowchart of image processing according to another embodiment of the present invention. A part of image of the fisheye lens 50 is cut to be a wide-angle image, which is performed by rotating the lens 90 degrees to face the shooting target. Therefore, in step S510, a central area 500 of the image of the fisheye lens 50 is directly captured to obtain a captured image, and then in step S511, the captured image is restored to generate a wide-angle image I_90 with an angle exceeding 90 degrees. FIG. 5D is a schematic diagram corresponding to FIG. 5B.

The image output unit 105 will perform further image signal processing, such as format conversion and compression, and the image of the shooting mode according to the above embodiments is transmitted by a wired interface, such as USB or Ethernet, and a wireless interface, such as Wi-Fi or wireless module, to the receiving device 2, such as a computer, a laptop, or a mobile device, or to an Internet.

The present invention is not limited to the above-mentioned embodiments. It is obvious to those skilled in the art that various modifications and changes can be made to the present invention without departing from the spirit or scope of the present invention.

Therefore, the present invention covers the present invention or the modifications and changes made within the scope of the attached claims and its equivalent scope.

What is claimed is:

1. A multifunctional camera, comprising:
a support part; and
a camera unit disposed on the support part, being capable of being adjusted to at least one shooting angle, and including a processor that can adjust the camera unit to be corresponding to the at least one shooting angle according to a switching signal,
wherein the at least one shooting angle corresponds to at least one shooting mode.

2. The multifunctional camera as claimed in claim 1, wherein the camera unit includes a gyro sensor coupled to the processor and detecting the at least one shooting angle to generate and input the switching signal to the processor.

3. The multifunctional camera as claimed in claim 1, further comprising an input unit receiving a user input signal to generate and input the switching signal to the processor.

4. The multifunctional camera as claimed in claim 1, wherein the camera unit is adjusted to a first shooting angle or a second shooting angle.

5. The multifunctional camera as claimed in claim 4, wherein the at least one shooting mode corresponding to the first shooting angle includes a full screen mode, a panoramic mode, a host mode, and a two speaker mode.

6. The multifunctional camera as claimed in claim 4, wherein the at least one shooting mode corresponding to the second shooting angle includes a single view S mode and a single view L mode.
